(19) United States
(12) Patent Application Publication
(10) Pub. No.: US 2020/0050956 A1
(43) Pub. Date: Feb. 13, 2020

(54) MODELING CONTRACT COMPONENTS AND ECOSYSTEM ACTIVITY

(71) Applicant: INTERNATIONAL BUSINESS MACHINES CORPORATION, Armonk, NY (US)

(72) Inventors: Mary Ellen Coleman, Rochester, NY (US); Kelley Anders, East New Market, MD (US); Jeremy R. Fox, Georgetown, TX (US); Jonathan Dunne, Dungarvan (IE)

(21) Appl. No.: 16/059,194

(22) Filed: Aug. 9, 2018

(51) Int. Cl. G06N 7/00; G06Q 10/06; G06K 9/62; G06N 5/04

(52) U.S. Cl. CPC G06N 7/00; G06N 5/04; G06K 9/628; G06Q 10/063

(57) ABSTRACT

A method for validating an engagement activity of a contract-bound party with respect to a contractual term is provided. The method may include generating first and second latent class models, including first and second sets of behavioral classes, respectively. The first model is generated based on a representative population of individuals, respective contractual activities of the individuals, and the contractual term. The second model is generated based on an actual population of individuals, respective contractual activities of the individuals, and the contractual term. The party is classified into a class of each set of classes, respectively, based on detection of the engagement activity. An inequivalency score is determined for the models based on the classifications of the party into the classes of each model, and responsive to determining that the score exceeds a predetermined threshold, a breach of the contractual term is detected, and a remedial action is performed.

### BACKGROUND

The present invention relates generally to the field of contract processing, and in particular to validating an engagement activity of a contract-bound party with respect to a contractual term of a contract.

A contract is a legally enforceable and binding agreement that, if violated, may provide legal recourse and remedies to an injured party. The contract may include contractual conditions, terms, and provisions by which boundaries or limitations of the agreement may be defined and specified. A contractual term may give rise to a contractual obligation. A breach of the contractual obligation may result in damages to contract-bound parties.

For example, an insurance contract or agreement is a contract whereby the insurer promises to pay benefits to the insured, or on their behalf to a third party, if certain defined events occur. In some cases, subject to the “fortuity principle”, such defined events must be uncertain. The uncertainty can be either as to when the event will happen (e.g. in a life insurance policy—when the time of the insured's death occurs) or as to if it will happen at all (e.g. in a fire insurance policy—if a property is ever set on fire).

### SUMMARY

According to an aspect of the present invention, a computer-implemented method, a computer system, and a computer program product for validating an engagement activity of a contract-bound party with respect to a contractual term is provided. The method may include generating first and second latent class models, including first and second sets of behavioral classes, respectively. The first model is generated based on a representative population of individuals, respective contractual activities of the individuals, and the contractual term. The second model is generated based on an actual population of individuals, respective contractual activities of the individuals, and the contractual term. The party is classified into a class of each set of classes, respectively, based on detection of the engagement activity. An inequivalency score is determined for the models based on the classifications of the party into the classes of each model, and responsive to determining that the score exceeds a predetermined threshold, a breach of the contractual term is detected, and a remedial action is performed.

### BRIEF DESCRIPTION OF THE DRAWINGS

FIG. 1 is a functional block diagram depicting a contract auditing system, in accordance with an embodiment of the present invention.

FIG. 2 is a flowchart depicting operational steps of an aspect of the contract auditing system, in accordance with an embodiment of the present invention.

FIG. 3 is a block diagram depicting a client device and/or a contract audit management device, in accordance with an embodiment of the present invention.

FIG. 4 depicts a cloud computing environment, in accordance with an embodiment of the present invention.

FIG. 5 depicts abstraction model layers, in accordance with an embodiment of the present invention.

The drawings are not necessarily to scale. The drawings are merely schematic representations, not intended to portray specific parameters of the invention. The drawings are intended to depict only typical embodiments of the invention. In the drawings, like numbering represents like elements.

### DETAILED DESCRIPTION

Detailed embodiments of the present invention are disclosed herein for purposes of describing and illustrating claimed structures and methods that may be embodied in various forms, and are not intended to be exhaustive in any way, or limited to the disclosed embodiments. Many modifications and variations will be apparent to those of ordinary skill in the art without departing from the scope and spirit of the disclosed embodiments. The terminology used herein was chosen to best explain the principles of the one or more embodiments, practical applications, or technical improvements over current technologies, or to enable those of ordinary skill in the art to understand the embodiments disclosed herein. As described, details of well-known features and techniques may be omitted to avoid unnecessarily obscuring the embodiments of the present invention.

References in the specification to “one embodiment,” “an embodiment,” “an example embodiment,” or the like, indicate that the embodiment described may include one or more particular features, structures, or characteristics, but it shall be understood that such particular features, structures, or characteristics may or may not be common to each and every disclosed embodiment of the present invention herein. Moreover, such phrases do not necessarily refer to any one particular embodiment per se. As such, when one or more particular features, structures, or characteristics is described in connection with an embodiment, it is submitted that it is within the knowledge of those skilled in the art to affect such one or more features, structures, or characteristics in connection with other embodiments, where applicable, whether or not explicitly described.

A contract may include and define contractual terms. The contractual terms may include contractual conditions, contractual warranties, and the like. For example, the contractual terms may be specified to define circumstances by which a first party (e.g., an insurer) may reimburse a second party (e.g., an insured) for damage or loss of personal property items (in the case of personal lines insurance policies) or for damage or loss of commercial property items such as inventory or equipment (in the case of commercial lines policies). The first and second parties may be bound by the contract. If an insured item of personal property belonging to the second party is stolen or damaged, the first party may reimburse the second party in accordance with the relevant contractual terms of the contract.

A contractual term may be subject to differing interpretations. That is, a contractual obligation or requirement of the contractual term, the contractual term itself, and other constituents of an associated contract may be perceived or understood differently by parties to the contract. For example, one or more of the parties may not sufficiently understand an obligation brought about by a contractual term due to a miscommunication of the contractual term. As a result, the contractual term may be understood to require an occurrence of distinct and conflicting events according to the parties. This may lead to an inadvertent failure by a contract-bound party to adhere to requirements of the contractual term as a result of activities of the contract-bound party, causing erroneous and inadvertent contract cancellations, and the like. The activities of a contract-bound party may include, for example, activities by which the contract-bound party may engage with a contract by which the party may be bound (hereinafter “engagement activities”). Under certain circumstances, the activities of the contract-bound party may indicate a misunderstanding of a contractual term by the party.

Accordingly, there is a need in the art for a method of validating an engagement activity of a contract-bound party with respect to a contractual term of a contract, to detect and remediate contractual conflicts caused by misunderstandings of the contractual term.

Embodiments of the present invention are directed to a method, system, and computer program product for validating an engagement activity of a contract-bound party with respect to a contractual term of a contract, to detect and remediate contractual conflicts caused by misunderstandings of the contractual term.

In various embodiments, the method may include generating a first latent class model comprising a first set of behavioral classes, wherein the first latent class model is generated based on a representative population of individuals, respective contractual activities of the individuals, and the contractual term. The method may further include generating a second latent class model comprising a second set of behavioral classes, wherein the second latent class model is generated based on an actual population of individuals, respective contractual activities of the individuals, and the contractual term. The method may further include detecting the engagement activity of a contract-bound party based on an occurrence of a contract engagement event. The method may further include classifying the contract-bound party into a behavioral class of each of the first and second sets of behavioral classes based on the detected engagement activity. The method may further include determining an inequivalency score based on the classifications of the contract-bound party into the behavioral classes of each of the first and second sets of behavioral classes. The inequivalency score may represent a level of inequivalency between the first latent class model and the second latent class model. In response to determining that the inequivalency score exceeds a predetermined threshold, the method may further include detecting a contractual conflict between the engagement activity and the contractual term, and performing a remedial action.

Advantageously, the present invention overcomes the aforementioned problems associated with conflicts caused by misunderstandings of a contractual term of a contract. In particular, the present invention enables validation of an engagement activity of a contract-bound party with respect to a contractual term of a contract to determine whether there may be a misunderstanding of the contractual term by the contract-bound party. The engagement activity may be indicative of the misunderstanding. To that end, the present invention may be implemented to mitigate conflicts caused by misunderstandings of the contractual term by parties of the contract. Further, the present invention may be implemented to determine and validate an engagement activity with respect to a corresponding contractual term. Further, the present invention may be implemented in gathering insights into the activities of contract-bound parties across a digital ecosystem (e.g. social media) with respect to contractual terms, policies, and updates. Other advantages will be readily apparent to those of skill in the art.

For purposes of the present disclosure, a “population of individuals” as used herein may refer to a population or sample of discrete statistical units. The population of individuals may include a population or group of contract-bound parties that may be bound by a common or substantially similar contract, or one or more common or substantially similar contractual terms. The population of contract-bound parties may otherwise exist in a common contractual environment and perform activities under similar conditions, constraints, and/or expectations in the contractual environment.

For purposes of the present disclosure, a “contract-bound party,” “contract-bound individual,” and the like, as used herein refers to an individual or group of individuals bound by a contract or one or more contractual terms of the contract.

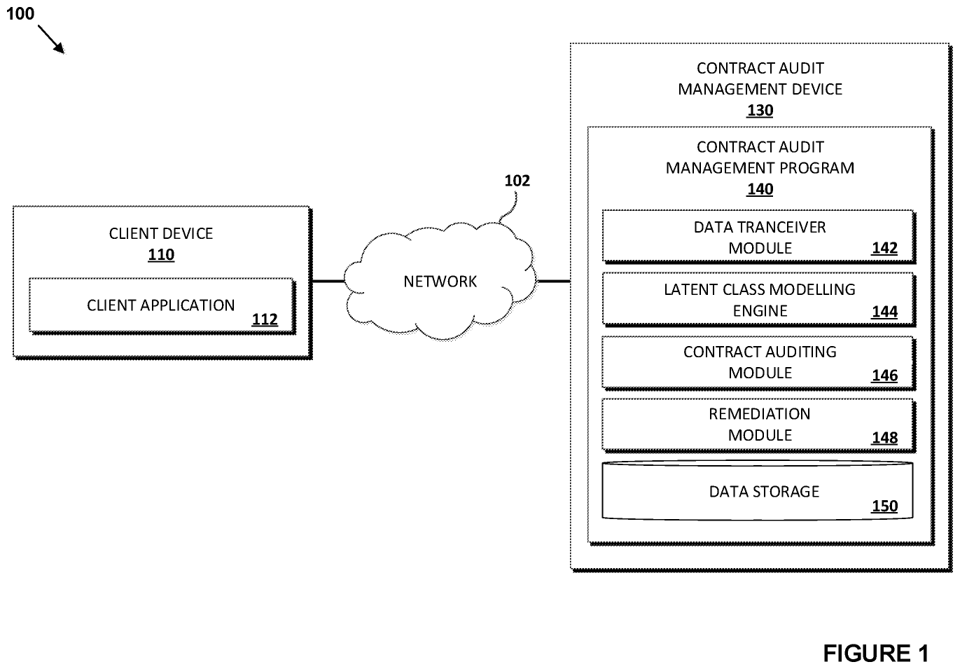

FIG. 1 is a functional block diagram depicting contract auditing system 100, in accordance with an embodiment of the present invention. Contract auditing system 100 may include client device 110 and contract audit management device 130 interconnected over network 102. While FIG. 1 depicts contract auditing system 100 as including three discrete devices, other arrangements may be contemplated. For example, contract auditing system 100 may include one or more devices such as client device 110 and/or contract audit management device 130, which may be collectively or individually formed by one or more integrated or distinct devices.

In various embodiments, network 102 may include, for example, an intranet, a local area network (LAN), a personal area network (PAN), a wireless local area network (WLAN), a wireless personal area network (WPAN), a wireless mesh network, a wide area network (WAN) such as the Internet, or the like. Network 102 may include wired, wireless, or fiber optic connections. Generally, network 102 may include any combination of connections and protocols for supporting communications between client device 110 and contract audit management device 130, in accordance with embodiments of the present invention.

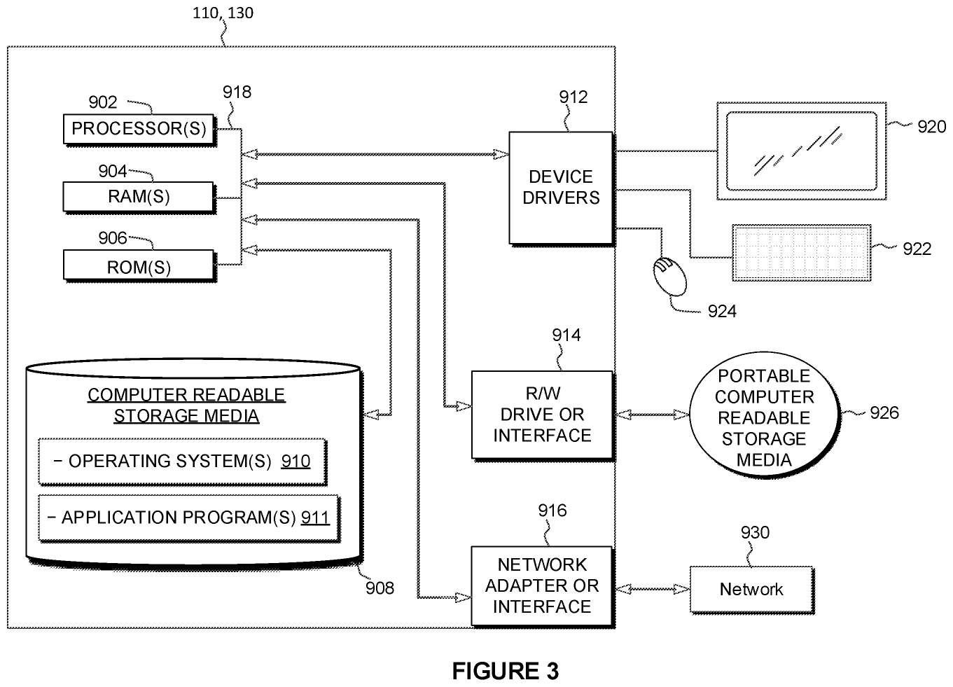

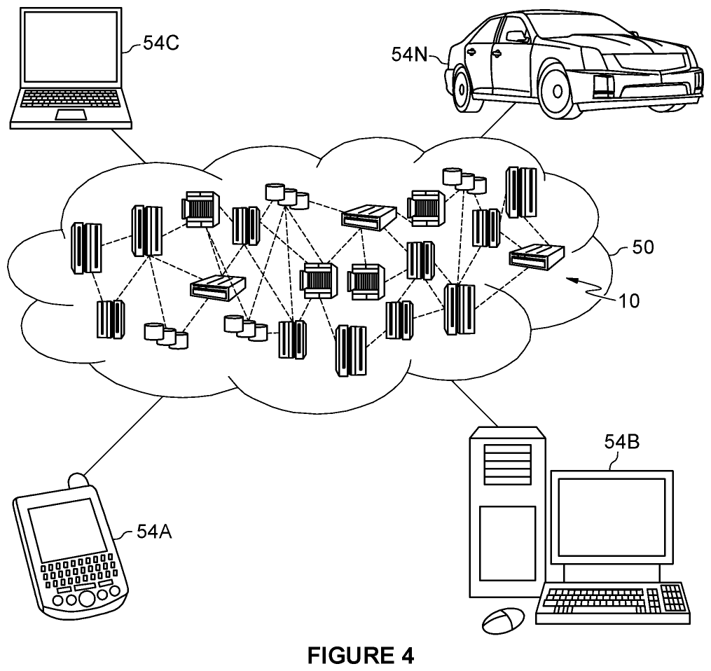

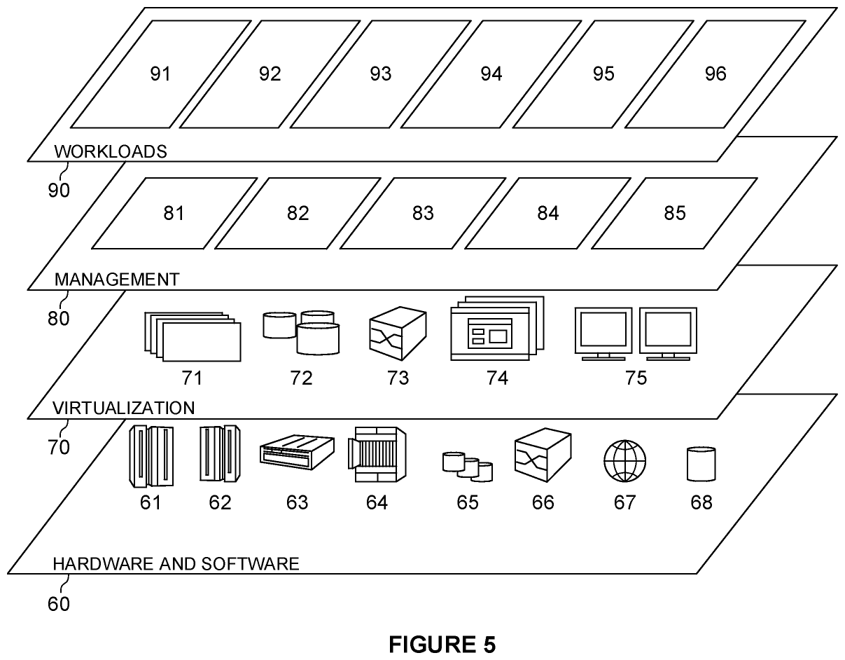

In various embodiments, client device 110 and/or contract audit management device 130 may include a computing platform or node such as a wearable device, an implantable device, a mobile or smart phone, a tablet computer, a laptop computer, a desktop computer, a server such as a database server, a virtual machine, or the like. In the various embodiments, client device 110 and/or contract audit management device 130 may otherwise include any other type of computing platform, computer system, or information system capable of sending and receiving data to and from another device, such as by way of network 102. In certain embodiments, client device 110 and/or contract audit management device 130 may include internal and external hardware components, as described with reference to FIG. 3. In other embodiments, client device 110 and/or contract audit management device 130 may be implemented in or by way of a cloud computing environment, as described with reference to FIGS. 4 and 5.

Client device 110 hosts client application 112. Client device 110 may implement a combination of devices and technologies such as network devices and device drivers to support the operation of client application 112, and provide a platform enabling communications between client device 110 and contract audit management device 130, in accordance with embodiments of the present invention.

Client application 112 may include an application or program such as a web or Internet-based application, a software program, one or more subroutines contained in a program, an application programming interface, and the like. Client application 112 may be implemented to support and facilitate data communications between client device 110 and a social media platform (not depicted), in accordance with embodiments of the present invention. For example, client application 112 may include a web application by which data may be digitally shared, exchanged, or otherwise communicated over network 102 between client device 110 and one or more computing platforms and/or computing applications of the social media platform. The social media platform may include, for example, a service provider such as an Internet or web hosting service, a file hosting service, a file sharing service, a social networking service, a photo- and/or video-sharing service, and/or an email service.

In an embodiment, client application 112 may be implemented by a contract-bound party in performing an engagement activity. For purposes of the present disclosure, a “contract-bound party” as used herein refers to a legal or contractual entity including or composed of one or more persons. The engagement activity may include an act performed by or on behalf of the contract-bound party in a contractual setting, as such setting may be defined by one or more contractual terms of a contract by which the party is bound. That is, the engagement activity of the contract-bound party may include or produce an occurrence of a contract engagement event, in which the contract-bound party accesses, engages, or otherwise interacts with a contractual entity, or otherwise performs activities in a contractual environment. The contractual entity (e.g., a healthcare provider) and the contractual environment (e.g., a hospital) may be defined by the associated contract by which the contract-bound party is bound. Performance of the engagement activity by the contract-bound party may, for example, include or otherwise produce an occurrence of a contract engagement event with respect to one or more of the contractual terms of the contract.

As an example, the engagement activity may be performed by the contract-bound party to manage a social network status or relationship on or by way of the social media platform. The engagement activity may include any act (e.g. post, like, photo/video tag, expressed interest, affiliation with a group, etc.) performed by or on behalf of the contract-bound party, as such may occur on or with respect to the social media platform. The engagement activity may be made of record on or by way of the social media platform, in accordance with embodiments of the present invention.

In an embodiment, an engagement activity of a contract-bound party may include, for example, social media activity such as “checking-in” to a location. Checking-in may include, for example, determining a location or physical position of the contract-bound party at a point in time, such as by applying a GPS or geofencing method. Checking-in may be associated with a service or appointment provided to the contract-bound party by a contractual entity. A particular instance of checking-in may correspond to a contract engagement event in which the contract-bound party interacts with the contractual entity. In the embodiment, checking-in may include, for example, determining a check-in type based on a calendar or schedule of the contract-bound party, a time of an associated engagement activity of the contract-bound party, and a location of the contract-bound party at the time of the associated engagement activity. In the embodiment, the engagement activity of the contract-bound party may otherwise include, for example, an interaction (e.g., a social media post) by which a location of the contract-bound party may be deduced or inferred.

Contract audit management device 130 hosts contract audit management program 140. Contract audit management device 130 may implement a combination of devices and technologies such as network devices and device drivers to support the operation of contract audit management program 140, and provide a platform enabling communications between client device 110 and contract audit management device 130, in accordance with embodiments of the present invention.

Contract audit management program 140 may include an application or program such as a web or Internet-based application, a software program, one or more subroutines contained in a program, an application programming interface, and the like. Contract audit management program 140 may include data transceiver module 142, latent class modelling engine 144, contract auditing module 146, remediation module 148, and data storage 150. Contract audit management program 140 may be implemented to monitor, audit, and validate engagement activities of a contract-bound party with respect to one or more contractual terms of a contract.

Data transceiver module 142 retrieves engagement activity data, contractual data, and personal characteristics data. Data transceiver module 142 stores the retrieved data in data storage 150 for use by contract audit management program 140. In retrieving the data, data transceiver module 142 may implement a data miner, a web crawler, or the like, in accordance with embodiments of the present invention.

In an embodiment, the engagement activity data may include data corresponding to an engagement activity of a contract-bound party as such may be performed by or on behalf of the contract-bound party with respect to a contractual term of a contract. The engagement activity data may include data indicative of an occurrence of a contract engagement event corresponding to the engagement activity of the contract-bound party. The engagement activity data may include data related to social media activity of the contract-bound party on a social media platform.

In an embodiment, the contractual data may include data corresponding to the contractual term of the contract associated with the contract-bound party. The contractual data may specify, relate to, and/or govern the definition of a contract engagement event corresponding to the contractual term. The contract engagement event may include an appropriate or expected engagement activity of the contract-bound party with respect to the contractual term.

In an embodiment, the personal characteristics data may include data corresponding to demographic and socioeconomic factors (hereinafter “demographic and socioeconomic factor data”) associated with a group of individual contract-bound parties (i.e. a population of discrete statistical units). The demographic and socioeconomic factors may include, for example, age, gender, ethnicity, urbanicity, school type, income level, education level, occupation, marital status, religion, disability, and/or community or home environment, as such may be associated with individual contract-bound parties. In the embodiment, the demographic and socioeconomic factor data may include and represent variables, parameters, and associated values thereof such as in the form of covariate variables, predictor variables, or explanatory variables (hereinafter, “covariate variable(s)”).

In an embodiment, a covariate variable may represent and correspond to a measurement, value, and/or observation of a demographic and/or socioeconomic factor that may be associated with each contract-bound party of a group of individual contract-bound parties. That is, a covariate variable may include any quantifiable or qualifiable measure or indication of a demographic and/or socioeconomic factor or status of a contract-bound party. In the embodiment, individual contract-bound parties may be related, characterized, categorized, or otherwise classified on the basis of a set of covariate variables. A covariate variable may be nominal, ordinal, or continuous. In the embodiment, a covariate variable may include a personal characteristic variable of a contract-bound party.

For example, each variable of a set of covariate variables may be associated with each member of a group of individual contract-bound parties. Each covariate variable may include a value for representing a measurement and/or observed indication of a particular demographic and/or socioeconomic factor with respect to a corresponding contract-bound party. For example, a value of a particular covariate variable may represent an age of a corresponding contract-bound party. As such, each of the covariate variables may quantify, qualify, or otherwise indicate a degree of influence of a corresponding demographic or socioeconomic factor on an associated contract-bound party.

In an embodiment, a covariate variable may reflect and correspond to a latent, unobservable variable (hereinafter, “latent variable”) associated with a contract-bound party. That is, a measure or value of a latent variable may be determined based on measures or values of one or more corresponding covariate variables. A latent variable (hereinafter “latent variable”) is a random variable that in principle (or in practice) cannot be directly observed; rather, its value can be deduced or inferred, such as by way of a mathematical or statistical model, based on observed and/or measured variables (i.e. covariates). For example, latent variables may represent corresponding unobservable latent variables such as preferences, behaviors, attitudes, or predispositions of a contract-bound party (e.g. of an individual). Latent variables may be categorical, continuous, nominal, or ordinal.

Latent class modelling engine 144 generates latent class models and classifies (i.e. groups, categorizes, clusters, etc.) individual contract-bound parties into individual latent behavioral classes of each of the models.

In an embodiment, latent class modelling engine 144 may implement a statistical method such as latent class analysis in generating latent class models and classifying individual contract-bound parties into corresponding latent behavioral classes of the models.

Latent class analysis is a statistical method and is a subset of structural equation modeling for determining latent class membership probabilities among statistical units (e.g. individual contract-bound parties) based on measurements and observations of a set of observable (i.e. covariate) variables. Latent class analysis assumes a parametric statistical model and uses observed data to determine covariate variable values for the selected model. In latent class analysis, categorical and continuous observed variables (i.e. covariate variables) are considered to classify each individual statistical unit (e.g. individual contract-bound parties). In other words, latent class analysis may be used to find groups or subtypes of cases in multivariate categorical data, such as to group individuals (cases, units, etc.) into classes (categories) of an unobserved (latent) variable on the basis of the responses, measurements, and/or observations made on a set of nominal, ordinal, or continuous observed variables (i.e. covariate variables). These groups or subtypes of cases are commonly called “latent classes”.

A latent class model relates a set of observed (usually discrete) multivariate variables to a set of latent variables. It is a type of latent variable model. It is called a latent class model because the latent variable is discrete. A class is characterized by a pattern of conditional probabilities that indicate the likelihood that variables (e.g. covariate variables) take on certain values. A latent class model may include latent classes that may each be defined and specified by one or more latent variables. Each of the latent variables may correspond to one or more covariate variables. For example, a latent class model may correspond to one or more latent variables by which a class of individuals may be classified on the basis of exhibited behavioral patterns.

In an embodiment, a latent class model may include a set of at least two latent classes to which each member of a group of individual contract-bound parties may be exclusively classified. A latent class may represent and correspond to one or more latent variables. A latent variable may include and correspond to one or more covariate variables. That is, the latent class model may be defined and specified in terms of sets of latent variables and corresponding covariate variables. One or more latent variables may be clustered to form a latent class.

Latent variables are variables that are not directly observed but are rather deduced or inferred from other variables that are measured or observed (i.e. directly), such as covariate variables as previously described. That is, a latent variable may in principle be measured, but may not be for practical reasons, and may instead be deduced or inferred based on measurement or observation of one or more corresponding covariate variables. A latent variable may correspond to an aspect of physical reality, such as in terms of behavioral or mental states or one or more categories thereof. That is, a latent variable may be associated with one or more covariate variables and a value of the latent variable may be determined based on measurements and/or observations of the one or more covariate variables. As such, a latent variable may relate an observable (“sub-symbolic”) variable such as a covariate variable in the real world to symbolic data in the modeled world.

In an embodiment, a latent variable may include and correspond to a behavioral indicator variable of a contract-bound party. The behavioral indicator variable may represent and correspond to a particular behavior or act by the contract-bound party.

In an embodiment, a latent class model may include a set of latent variables that may be determined based on measurement and/or observation of one or more associated covariate variables. In the embodiment, subsets of the latent variables may be aggregated or clustered to represent one or more underlying concepts or factors associated with a contract-bound party. In the embodiment, a latent variable may be defined to represent an underlying concept or factor (e.g., a behavioral variable) associated with the contract-bound party, and may correspond to a predisposition of the contract-bound party to act in a particular manner with respect to a contractual term.

In an embodiment, a covariate variable may be measured and/or observed by detecting an occurrence of a contract engagement event. In the embodiment, the contract engagement event may include an engagement activity of a contract-bound party corresponding to an occurrence of a contract engagement event, as previously described. Generally, covariate variables may be associated with corresponding latent variables to support representation of underlying concepts or factors by the latent variables, and may correspond to a predisposition of the contract-bound party to act in a particular manner with respect to a contractual term.

In an embodiment, a covariate variable may include or correspond to a personal characteristic or variable of a contract-bound party. The covariate variable may be implemented in determining latent class membership probability of the contract-bound party with respect to classification of the party into one of a set of latent classes of a latent class model. That is, a covariate variable may be implemented in a latent class model to determine latent class membership probability of a contract-bound party in a latent class of a set of latent classes of the latent class model.

Contract auditing module 146 detects engagement activities of contract-bound parties with respect to occurrences of contract engagement events, and classifies individual contract-bound parties into one of a set of latent classes, accordingly. Contract auditing module 146 further detects contractual conflicts caused by potential misunderstandings of contractual terms of an associated contract.

In an embodiment, an engagement activity of a contract-bound party may be detected based on and with respect to one or more corresponding covariate variables. The one or more covariate variables may be associated with a latent variable, as previously described. Contract auditing module 146 may implement any type of classification engine such as a natural language processing system, a natural language classifier, and the like, to detect the engagement activity, in accordance with embodiments of the present invention.

In an embodiment, a detected conflict may include a contractual conflict between an engagement activity of a contract-bound party and a contractual term. In the embodiment, the conflict may be detected based on social media activity of the contract-bound party. That is, the detected conflict may include any act or behavior by and of the contract-bound party to engage with the contractual term in a manner inconsistent with those defined by the contractual term. The contractual term may include and define an expected contractual activity by which the contract-bound party may ideally engage with the contractual term in accordance with requirements of the contractual term.

For example, a conflict may be detected based on social media activity of a contract-bound party, where the social media activity includes a check-in instance by the contract-bound party at a specific location on a specific date and time. Where an expected engagement activity of the contract-bound party includes being at a different location on the specific date and time, such as for a doctor's appointment, the conflict may be detected, accordingly.

Remediation module 148 performs remedial actions with respect to detected contractual conflicts. Remediation module 148 may further identify, detect, or determine a potential misunderstanding of a contractual term by a contract-bound party.

In an embodiment, a remedial action may include, for example, generating an alert corresponding to a detected contractual conflict. The alert may be generated for display by a computing platform and viewing by an operator (e.g., a contract auditor). The alert may include a summary of a potential misunderstanding of a contractual term by a contract-bound party. The alert may include a probability or likelihood score of the potential misunderstanding, in fact. Remediation module 148 may implement any type of classification engine such as a natural language processing system, a natural language classifier, and the like, in accordance with embodiments of the present invention.

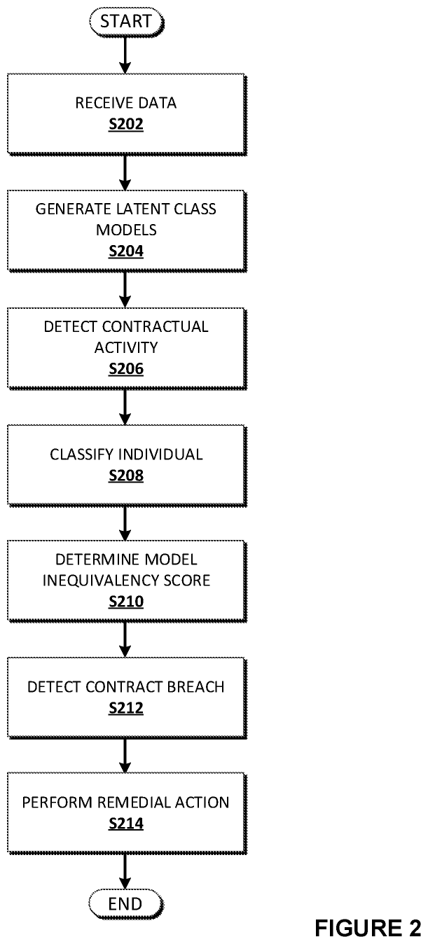

FIG. 2 is a flowchart depicting operational steps of an aspect of contract auditing system 100, in accordance with an embodiment of the present invention.

At Step S202, data transceiver module 142 retrieves or otherwise receives the engagement activity data, the contractual data, and optionally, the personal characteristics data. Data transceiver module 142 may implement any type of data mining method to retrieve the data, in accordance with embodiments of the present invention.

In an embodiment, the engagement activity data may be retrieved from a data mining source such as a social media server using any applicable data mining technique. The engagement activity data may be retrieved so as to include social media activity data corresponding to a history of activity of a contract-bound party on a social media platform. The social media activity may include, for example, participation and activities by the contract-bound party in one or more forums or common interest(s) groups, “likes”, comments, message posts, and messages sent or received by the contract-bound party. The engagement activity data relating to social media history may include information content uploaded by the user in various forms, including, for example, image files, video files, audio files, posts consisting of text or words and/or emoticons or “emojis”.

In an embodiment, the contractual data may be retrieved from a data mining source such as a contract database server using any applicable data mining technique.

In an embodiment, the personal characteristics data may be retrieved from a data mining source such as a demographics server using any applicable data mining technique. The demographics server may include, for example, one that is publicly owned and maintained, such as by the United States Census Bureau.

At Step S204, latent class modelling engine 144 generates latent class models for validating an engagement activity of a contract-bound party with respect to a contractual term of a contract.

In an embodiment, generating the latent class models may include generating a first latent class model including a first set of behavioral classes. The first latent class model may be generated based on a representative population of users (i.e. individuals), respective contractual activities of the individuals, and the contractual term. In the embodiment, generating the latent class models may further include generating a second latent class model including a second set of behavioral classes. The second latent class model may be generated based on an actual population of users (i.e. individuals), respective contractual activities of the individuals, and the contractual term. The representative and actual population of users may include statistical units corresponding to modeled and actual contract-bound parties, respectively.

Latent class modelling engine 144 may implement any type of latent class analysis and modelling method in generating the latent class models, in accordance with embodiments of the present invention. In the embodiment, generating the latent class models may include fitting a latent class model to a set of latent variables and determining the latent class model having a (relative) best-fit.

In an embodiment, a latent variable may be associated with a contract-bound party on the basis of one or more covariate variables corresponding to the latent variable. A contract-bound party may be classified into a latent class with respect to the one or more latent variables by which the latent class is defined based on measurements and observations of one or more covariate variables corresponding to the one or more latent variables of the latent class. Each of the covariate variables may be respectively associated with the contract-bound party as previously described. A latent class model may include and be defined by a set of covariate variables, local dependencies, ordinal and continuous variables, at least two latent variables, and/or repeated measures, in accordance with embodiments of the present invention.

Generating the latent class model may include fitting a latent class model to a set of latent variables. For example, a latent class model may be fit to a set of latent variables by implementing maximum likelihood latent structure analysis (MLLSA). The latent variables may include, for example, nominal, ordinal, discrete, and continuous variables or parameters.

In an embodiment, a pair of latent class models (i.e., a first latent class model and a second latent class model) may each be generated based on one of a representative and actual population of contract-bound parties (e.g., individuals), respective contractual activities of the contract-bound parties, and corresponding contractual terms of an associated contract. The representative population of contract-bound parties may include individuals historically bound by a contractual term. The actual population of contract-bound parties may include individuals currently bound by the contractual term. Sample sizes of the populations of contract-bound parties may be determined based on the particular latent class analysis and modelling method implemented, in accordance with embodiments of the present invention.

In an embodiment, a latent class model may be generated for classifying each contract-bound party of a population into one of a set of latent classes (e.g., categories of latent variables) of the latent class model. The latent class model may be generated so as to incorporate one or more covariate variables, as previously described. The latent class model may be generated for determining possible categories or classes associated with a latent attribute. The classes may include contract-bound parties of the populations of contract-bound parties.

At Step S206, contract auditing module 146 detects the contractual activity associated with the contract-bound party based on an occurrence of a contract engagement event.

In an embodiment, the contractual activity may be detected by implementing a data mining method and a pattern matching method with respect to the social media activity of the contract-bound party. Any data mining and pattern matching method may be implemented to detect the contractual activity based on the occurrence of the contract engagement event, in accordance with embodiments of the present invention.

At Step S208, contract auditing module 146 classifies the contract-bound party into a behavioral (i.e. latent) class of the first and second sets of behavioral classes, respectively, based on the detected contractual activity of the contract-bound party. The contract-bound party may be classified with respect to the behavioral classes according to the conditions modeled by the first and second latent class models, respectively. The contract-bound party may include one or more individuals.

In an embodiment, classifying the contract-bound party into a latent class may include determining a latent class membership probability of the classification of the contract-bound party into the latent class. That is, each contract-bound party has a certain probability of membership to each latent class. Observations within the same latent class are homogeneous on certain criteria, whereas those in different latent classes are dissimilar from each other.

In an embodiment, the contract-bound party may be classified into a latent behavioral class of a latent class model based on an engagement activity of the party. In the embodiment, the contract-bound party may be classified into a class with respect to an observable variable on the basis of an occurrence of a contract engagement event.

In an embodiment, classifying a contract-bound party into a latent class may include determining a probability or likelihood of occurrence of the detected contractual activity of the contract-bound party, conditional upon the class membership of the contract-bound party. That is, the probability or likelihood of the detected contractual activity of the contract-bound party may represent and correspond to the probability for a contract-bound party such as an individual to perform a particular engagement activity, given that she or he has been classified in a specific latent class. The engagement activity may include, for example, a manner of providing a certain response to a specific item (e.g., a survey hosted on a social media platform), checking-in to a particular location, and the like.

In an embodiment, a likelihood of an occurrence of a contract engagement event of a contract-bound party may be determined based on one or more latent variables associated with the contract-bound party. In the embodiment, the contract engagement event may include an engagement activity of the contract-bound party. For example, a likelihood of an occurrence of a contract engagement event in which a contract-bound party accesses, engages, or otherwise interacts with a contractual entity, or otherwise performs acts in a contractual environment in relation to a contractual term, may be determined based on one or more latent variables associated with the contract-bound party. In other words, a contract-bound party may be classified based on one or more associated latent variables, and a likelihood of an occurrence of a contract engagement event of the contract-bound party may be determined according to the classification. In the embodiment, the contract-bound party may be classified into a latent class based on the likelihood of the occurrence of the contract engagement event.

For example, a contract-bound party may be predisposed—and therefore more likely—to perform or participate in certain engagement activities if the contract-bound party has a certain attitude, or is otherwise associated with or subject to a certain influential latent variable. By determining (i.e. via measurement or observation) the latent variable with which the contract-bound party is associated, a likelihood that the contract-bound party may perform certain engagement activities may be determined. Where the likelihood is high, for example, preemptive actions may be taken to prevent the engagement activities by the contract-bound party such as to mitigate conflict that may arise as a result. That is, certain characteristics and attributes (latent variables) of the contract-bound party may be indicative of the types of engagement activities that may be performed by and of the contract-bound party.

As another example, it may be difficult to know whether an individual (i.e. a contract-bound party) is a drug abuser if the individual does not admit to it; nevertheless, if we know the individual's preferences and what the individual thinks about drug use (i.e. covariates), the individual may be classified, with a degree of confidence, as a drug abuser. In this example, a latent variable associated with the individual may include an indication as to whether the individual is or is not a drug abuser. The latent variable may be determined (i.e. deduced or inferred) based on one or more observations of covariates, such as with respect to the individual's preferences and what the individual thinks about drug use.

At Step S210, contract auditing module 146 determines a model inequivalency score. The model inequivalency score may be determined for comparison of the first and second latent class models. The inequivalency score may represent and correspond to a level of inequivalency between the first latent class model and the second latent class model.

In an embodiment, an inequivalency score may be determined based on classifications of the contract-bound party into a behavioral class of each of the first and second sets of behavioral classes, as defined by the first and second latent class models, respectively. In the embodiment, the inequivalency score may include a value corresponding to a measured difference or delta between the first and second latent class models, with respect to the classifications of the contract-bound party into the behavioral class of the first and second sets of behavioral classes.

For example, particular classifications of the contract-bound party into a behavioral class of the first and second sets of behavioral classes may be compared with respect to the social media activity by which the contract-bound party was classified. The comparison may be performed based on the one or more latent variables by which the behavioral class of the first and second sets of behavioral classes is defined. Alternatively or in addition, the comparison may be performed based on the one or more covariate variables associated with the one or more latent variables by which the behavioral classes are defined. Generally, any method of determining the inequivalency score may be implemented so as to represent the measured difference or delta between the first and second latent class models, in accordance with embodiments of the present invention.

At Step S212, remediation module 148 detects a contractual breach. The contractual breach may include a conflict between the contractual activity and the contractual condition of the contract by which the contract-bound party is bound.

In an embodiment, the contractual breach may be detected in response to determining that the inequivalency score exceeds a predetermined threshold. An instance where the inequivalency score exceeds the predetermined threshold may correspond to a breach of contractual boundaries as defined by one or more contractual terms. In the embodiment, the predetermined threshold may be defined with respect to the inequivalency score in terms of a specific magnitude or extent of the difference or delta between the first and second latent class models. The predetermined threshold may otherwise be defined as a matter of design, in accordance with embodiments of the present invention.

At Step S214, remediation module 148 performs a remedial action. The remedial action may be performed to resolve a contractual and/or behavioral conflict, as previously described.

In an embodiment, performing a remedial action may include, for example, generating an alert such as for output and display via a monitor. The alert may be generated with respect to social media activity corresponding to an engagement activity of a contract-bound party. In the embodiment, the generated alert may be implemented in preventing the contract-bound party from performing the engagement activity so as to prevent a contractual breach from occurring.

In an embodiment, the remedial action may include, for example, updating or revising a contractual term. The contractual term may be updated based on engagement activities of a sample or population of contract-bound parties that commonly result in the occurrence of contractual breaches.

In an embodiment, the remedial action may include, for example, performing a contract enforcement action. The contract enforcement action may include, for example, increasing a premium cost, withholding a benefit associated with a contractual term, and the like.

As an example to illustrate application of an embodiment of the present invention, in an insurance use case, an engagement activity may include a claim by an individual (i.e. a contract-bound party) of a lower premium based on the installation of an intruder alarm. However, analysis of google street view data may invalidate the claim. As a result, a remedial action may include performing a contract enforcement action to instead increase the premium.

FIG. 3 is a block diagram depicting client device 110 and/or contract audit management device 130, in accordance with an embodiment of the present invention.

As depicted in FIG. 3, client device 110 and/or contract audit management device 130 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. The network adapter 916 communicates with a network 930. Communications fabric 918 may be implemented with any architecture designed for passing data and/or control information between processors (such as microprocessors, communications and network processors, etc.), system memory, peripheral devices, and any other hardware components within a system.

One or more operating systems 910, and one or more application programs 911, such as contract audit management program 140 residing on contract audit management device 130, as depicted in FIG. 1, are stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Client device 110 and/or contract audit management device 130 may also include a R/W drive or interface 914 to read from and write to one or more portable computer readable storage media 926. Application programs 911 on client device 110 and/or contract audit management device 130 may be stored on one or more of the portable computer readable storage media 926, read via the respective R/W drive or interface 914 and loaded into the respective computer readable storage media 908. Client device 110 and/or contract audit management device 130 may also include a network adapter or interface 916, such as a Transmission Control Protocol (TCP)/Internet Protocol (IP) adapter card or wireless communication adapter (such as a 4G wireless communication adapter using Orthogonal Frequency Division Multiple Access (OFDMA) technology). Application programs 911 on the server 220 may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers. Client device 110 and/or contract audit management device 130 may also include a display screen 920, a keyboard or keypad 922, and a computer mouse or touchpad 924. Device drivers 912 interface to display screen 920 for imaging, to keyboard or keypad 922, to computer mouse or touchpad 924, and/or to display screen 920 for pressure sensing of alphanumeric character entry and user selections. The device drivers 912, R/W drive or interface 914 and network adapter or interface 916 may include hardware and software (stored on computer readable storage media 908 and/or ROM 906).

Client device 110 and/or contract audit management device 130 can be a standalone network server, or represent functionality integrated into one or more network systems. In general, client device 110 and/or contract audit management device 130 can be a laptop computer, desktop computer, specialized computer server, or any other computer system known in the art. In certain embodiments, client device 110 and/or contract audit management device 130 represents computer systems utilizing clustered computers and components to act as a single pool of seamless resources when accessed through a network, such as a LAN, WAN, or a combination of the two. This implementation may be preferred for data centers and for cloud computing applications. In general, client device 110 and/or contract audit management device 130 can be any programmable electronic device, or can be any combination of such devices.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and contract auditing 96. Contract auditing 96 may include functionality enabling the cloud computing environment to perform holographic display rendering, in accordance with embodiments of the present invention.

While the invention has been shown and described with reference to certain exemplary embodiments thereof, it will be understood by those skilled in the art that various changes in form and details may be made therein without departing from the spirit and scope of the present invention as defined by the appended claims and their equivalents. Therefore, the present invention has been disclosed by way of example for purposes of illustration, and not limitation.

What is claimed is:

1. A computer-implemented method for validating an engagement activity of a contract-bound party with respect to a contractual term of a contract, the method comprising:
generating a first latent class model comprising a first set of behavioral classes, wherein the first latent class model is generated based on a representative population of individuals, respective contractual activities of the individuals, and the contractual term;
generating a second latent class model comprising a second set of behavioral classes, wherein the second latent class model is generated based on an actual population of individuals, respective contractual activities of the individuals, and the contractual term;
detecting the engagement activity of the contract-bound party based on an occurrence of a contract engagement event;
classifying the contract-bound party into a behavioral class of each of the first and second sets of behavioral classes, respectively, based on the detected contractual activity;
determining an inequivalency score based on the classifications of the contract-bound party into the behavioral classes of each of the first and second sets of behavioral classes, wherein the inequivalency score represents a level of inequivalency between the first latent class model and the second latent class model; and
in response to determining that the inequivalency score exceeds a predetermined threshold:
detecting a contractual breach corresponding to a contractual conflict between the engagement activity and the contractual term; and
performing a remedial action.

2. The computer-implemented method of claim 1, wherein the contract engagement event comprises one or more covariate variables by which the contract-bound party is classified.

3. The computer-implemented method of claim 2, wherein classifying the contract-bound party into a behavioral class of each of the first and second sets of behavioral classes comprises:
grouping the contract-bound party into a latent class defined with respect to a latent variable corresponding to one or more of the covariate variables; and
determining a probability of class membership of the contract-bound party in the latent class based on the one or more covariate variables corresponding to the latent variable.

4. The computer-implemented method of claim 1, wherein the contract engagement event comprises social media activity by which the engagement activity of the contract-bound party is detected.

5. The computer-implemented method of claim 4, wherein the contractual conflict comprises a discrepancy between the social media activity of the contract-bound party and an expected contractual activity of the contractual term.

6. The computer-implemented method of claim 1, wherein performing the remedial action comprises:
generating an alert based on the detected contractual breach with respect to the social media activity of the contract-bound party and the contractual term.

7. A computer system for validating an engagement activity of a contract-bound party with respect to a contractual term of a contract, the computer system comprising:
one or more computer processors, one or more computer-readable storage media, and program instructions stored on one or more of the computer-readable storage media for execution by at least one of the one or more computer processors, the program instructions, when executed by the at least one of the one or more computer processors, causing the computer system to perform a method comprising:
generating a first latent class model comprising a first set of behavioral classes, wherein the first latent class model is generated based on a representative population of individuals, respective contractual activities of the individuals, and the contractual term;
generating a second latent class model comprising a second set of behavioral classes, wherein the second latent class model is generated based on an actual population of individuals, respective contractual activities of the individuals, and the contractual term;
detecting the engagement activity of the contract-bound party based on an occurrence of a contract engagement event;
classifying the contract-bound party into a behavioral class of each of the first and second sets of behavioral classes, respectively, based on the detected contractual activity;
determining an inequivalency score based on the classifications of the contract-bound party into the behavioral classes of each of the first and second sets of behavioral classes, wherein the inequivalency score represents a level of inequivalency between the first latent class model and the second latent class model; and
in response to determining that the inequivalency score exceeds a predetermined threshold:
detecting a contractual breach corresponding to a contractual conflict between the engagement activity and the contractual term; and
performing a remedial action.

8. The computer system of claim 7, wherein the contract engagement event comprises one or more covariate variables by which the contract-bound party is classified.

9. The computer system of claim 8, wherein classifying the contract-bound party into a behavioral class of each of the first and second sets of behavioral classes comprises:
grouping the contract-bound party into a latent class defined with respect to a latent variable corresponding to one or more of the covariate variables; and
determining a probability of class membership of the contract-bound party in the latent class based on the one or more covariate variables corresponding to the latent variable.

10. The computer system of claim 7, wherein the contract engagement event comprises social media activity by which the engagement activity of the contract-bound party is detected.

11. The computer system of claim 10, wherein the contractual conflict comprises a discrepancy between the social media activity of the contract-bound party and an expected contractual activity of the contractual term.

12. The computer system of claim 7, wherein performing the remedial action comprises:
generating an alert based on the detected contractual breach with respect to the social media activity of the contract-bound party and the contractual term

13. A computer program product for validating an engagement activity of a contract-bound party with respect to a contractual term of a contract, the computer program product comprising:
one or more computer-readable storage devices and program instructions stored on at least one of the one or more computer-readable storage devices for execution by at least one or more computer processors of a computer system, the program instructions, when executed by the at least one of the one or more computer processors, causing the computer system to perform a method comprising:
generating a first latent class model comprising a first set of behavioral classes, wherein the first latent class model is generated based on a representative population of individuals, respective contractual activities of the individuals, and the contractual term;
generating a second latent class model comprising a second set of behavioral classes, wherein the second latent class model is generated based on an actual population of individuals, respective contractual activities of the individuals, and the contractual term;
detecting the engagement activity of the contract-bound party based on an occurrence of a contract engagement event;
classifying the contract-bound party into a behavioral class of each of the first and second sets of behavioral classes, respectively, based on the detected contractual activity;
determining an inequivalency score based on the classifications of the contract-bound party into the behavioral classes of each of the first and second sets of behavioral classes, wherein the inequivalency score represents a level of inequivalency between the first latent class model and the second latent class model; and
in response to determining that the inequivalency score exceeds a predetermined threshold:
detecting a contractual breach corresponding to a contractual conflict between the engagement activity and the contractual term; and
performing a remedial action.

14. The computer program product of claim 13, wherein the contract engagement event comprises one or more covariate variables by which the contract-bound party is classified.

15. The computer program product of claim 14, wherein classifying the contract-bound party into a behavioral class of each of the first and second sets of behavioral classes comprises:
grouping the contract-bound party into a latent class defined with respect to a latent variable corresponding to one or more of the covariate variables; and
determining a probability of class membership of the contract-bound party in the latent class based on the one or more covariate variables corresponding to the latent variable.

16. The computer program product of claim 13, wherein the contract engagement event comprises social media activity by which the engagement activity of the contract-bound party is detected.

17. The computer program product of claim 16, wherein the contractual conflict comprises a discrepancy between the social media activity of the contract-bound party and an expected contractual activity of the contractual term.

18. The computer program product of claim 13, wherein performing the remedial action comprises:
generating an alert based on the detected contractual breach with respect to the social media activity of the contract-bound party and the contractual term.
